(19) United States
(12) Patent Application Publication
(10) Pub. No.: US 2016/0314319 A1
(43) Pub. Date: Oct. 27, 2016

(54) HARDWARE BASED SECURITY APPARATUS AND SECURITY METHOD USING THE SAME

(71) Applicant: Korea Advanced Institute of Science And Technology, Daejeon (KR)

(72) Inventors: Yang-Kyu CHOI, Daejeon (KR); Jun-Young PARK, Daejeon (KR); Dong-II MOON, Daejeon (KR)

(73) Assignee: Korea Advanced Institute of Science And Technology, Daejeon (KR)

(21) Appl. No.: 15/007,630

(22) Filed: Jan. 27, 2016

(30) Foreign Application Priority Data
Apr. 27, 2015 (KR) 10-2015-0059010

(51) Int. Cl. G06F 21/81; G06F 21/55; H04L 29/06

(52) U.S. Cl. CPC G06F 21/81; H04L 63/0209; G06F 21/55; G06F 2221/034

(57) ABSTRACT

Disclosed are a hardware-based selective security apparatus and a security method using the same. The security apparatus according to an embodiment of the present invention includes: a transistor including a source electrode, a drain electrode, and a gate electrode composed of at least two electrodes; and a controller which selectively sets a security level 1 or a security level 2 by controlling a magnitude of a voltage which is applied to the gate electrode. According to the present invention, since there is no necessity of an additional space for a separate chip required by an existing hardware based security method, it is possible to obtain a recoverable hardware based security method which uses spaces usefully and has economic efficiency. Also, a recoverable security level and an irrecoverable security level are selectively applied, so that it is possible to implement an enhanced hardware-based security method.

### CROSS-REFERENCE TO RELATED PATENT APPLICATIONS

The present application claims the benefit of Korean Patent Application Serial No. 10-2015-0059010 filed Apr. 27, 2015; the entireties of which are all incorporated herein by reference.

### BACKGROUND

1. Field

The present invention relates to a hardware-based selective security apparatus and a security method using the same, and more particularly to a hardware-based selective security apparatus to which a security level can be selectively applied according to a security rating by using a security transistor, and a security method using the same.

2. Description of the Related Art

Security methods which are now being used in devices including a mobile device are most composed of only software. However, the security method composed of software has problems related to backtracking of a security function through reverse engineering, the replication of an input value, and forgery and modification of software.

Today, since personal information including financial information is highly thought of, these problems of the software-based security cannot be ignored any longer. Therefore, there are demands for new security methods for constructing more perfect security systems.

One of the new security methods is to use hardware. A representative hardware based security method currently employed physically divides the hardware into a security area and a central processing unit and uses them. This method is not enough to secure the security of the storage space, security of input, and security of booting. Besides, more than anything else, this method does necessarily require a separate chip for security of hardware. Therefore, it is impossible to avoid the cost increase.

There are other hardware based security methods such as a degaussing method, a low level format method, etc. These methods focus on only hardware destruction. That is, there is no method for recovering the destroyed system.

### SUMMARY

### Summary

One embodiment is a hardware-based selective security apparatus including: a transistor comprising a source electrode, a drain electrode, and a gate electrode composed of at least two electrodes; and a controller which selectively sets any one of security levels having mutually different security ratings by controlling a magnitude of a voltage which is applied to the gate electrode.

The controller may apply a voltage in a predetermined range, which distorts characteristics of the transistor, to the source electrode, the drain electrode, and the gate electrode, and thus, may set a security level 1.

The controller may apply a recovery voltage for recovering the characteristics of the transistor in the security level 1 to the gate electrode, and then may recover the characteristics of the transistor to an initial state.

Depending on a range of the recovery voltage, a degree of recovery of the characteristics of the transistor may be determined differently.

The characteristics of the transistor may be distorted by any one of a hot carrier, Fowler-Nordheim (FN) tunneling, negative bias temperature instability (NBTI), positive bias temperature instability (PBTI), transistor degradation by a radiation.

The controller may apply a breakdown voltage, which destroys the transistor irrecoverably, to the gate electrode, and thus, may set a security level 2.

The irrecoverable destruction of the transistor may include physical destruction, chemical destruction, physical/chemical/electrical destructions of a gate insulator, and channel area destruction.

Depending on a range of the breakdown voltage, a degree of destruction of the characteristics of the transistor may be determined differently.

The security level may include a recoverable security level 1 and an irrecoverable security level 2.

Another embodiment is a hardware-based selective security method including: monitoring whether an external intrusion into a system occurs or not; determining a security rating for the detected external intrusion; and setting any one of security levels having mutually different security ratings in accordance with the determined security rating.

The setting the security level may mean that a recoverable security level 1 or an irrecoverable security level 2 is set.

The security level 1 and the security level 2 may be applied by distorting or destroying characteristics of at least one transistor provided within the system.

The at least one transistor may be distorted by applying a voltage in a predetermined range to a source electrode, a drain electrode, and a gate electrode provided in the transistor. The at least one transistor may be recovered by applying a recovery voltage in a predetermined range to the gate electrode provided in the transistor.

The at least one transistor may be destroyed by applying a breakdown voltage to the gate electrode provided in the transistor.

When it is determined that the external intrusion is removed after the security level 1 is set, the distorted characteristics of the at least one transistor may be recovered to an initial state, and then the security level 1 can be released.

### BRIEF DESCRIPTION OF THE DRAWINGS

FIG. 1 is a view schematically showing a security method according to an embodiment of the present invention;

FIG. 2 is a view showing a configuration of a transistor which is used in a security apparatus according to the embodiment of the present invention;

FIG. 3 is a view for describing recovery and destruction of the transistor which is used in a security apparatus according to the embodiment of the present invention;

FIG. 4 is a graph showing a measurement result of the transistor of which the characteristics have been distorted through a hot carrier degradation in the security apparatus according to the embodiment of the present invention;

FIG. 5 is a graph showing that the characteristics of the transistor, which have been distorted through the hot carrier degradation by the hot carrier, are recovered by a recovery voltage in the security apparatus according to the embodiment of the present invention;

FIG. 6 is a graph showing a state of the transistor destroyed by a breakdown voltage in the security apparatus according to the embodiment of the present invention;

FIG. 7 is a view showing a schematized driving method of the transistor provided in the security apparatus according to the embodiment of the present invention; and

FIG. 8 is a flowchart showing the security method according to the embodiment of the present invention.

### DETAILED DESCRIPTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

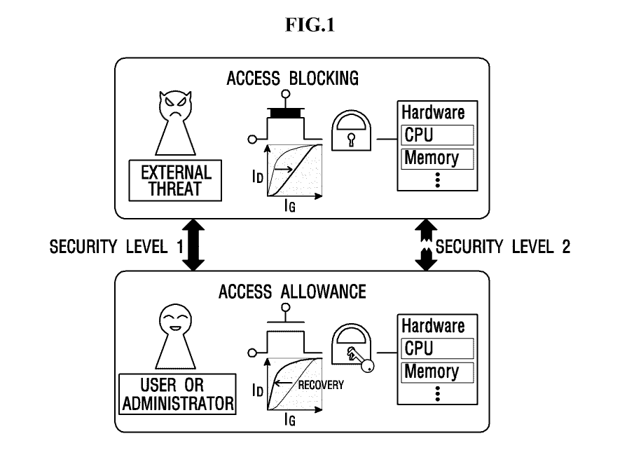

FIG. 1 is a view schematically showing a security method according to an embodiment of the present invention.

In a hardware-based selective security method according to the embodiment of the present invention, it is possible to selectively select a security level 1 and a security level 2 by using a transistor. First, when an external intrusion is detected while continuously monitoring the external intrusion, the security level 1 or the security level 2 is set. Here, the security level 1 means that the external intrusion is blocked by temporarily distorting the characteristics of the transistor. The security level 2 means that the external intrusion is blocked by permanently destroying the transistor.

Depending on the result of monitoring the external intrusion, when it is determined that a high security level is required for the detected external intrusion, the security level 2 is set, or when it is determined that a low security level is required, the security level 1 is set.

Here, a method for distorting the characteristics of the transistor for constructing the security level 1 is to degrade the transistor. The transistor may be degraded by various trapping or de-trapping methods such as a hot carrier degradation, Fowler-Nordheim (FN) tunneling, negative bias temperature instability (NBTI), positive bias temperature instability (PBTI), and transistor degradation by a radiation, etc. Hereinafter, for convenience of description, the method for distorting the characteristics of the transistor will be consistently described by assuming that the hot carrier degradation is used. However, it is apparent to those skilled in the art that the present invention can use the above various methods without being limited to this.

Here, the hot carrier will be briefly described. When a voltage is applied to a drain electrode of the transistor, a large electric field is generated around the drain electrode. Then, a carrier which has flowed into the electric field obtains a large amount of energy from the electric field and the hot carrier is produced. The hot carrier having high energy passes through a Si—SiO₂ energy barrier and is injected into a gate oxide film. Due to such a phenomenon, a threshold voltage and transconductance are changed, so that the characteristics of the transistor become degraded.

The phenomenon in which the degradation occurs by the above-mentioned other methods has been already known to skilled persons in the art, a detailed description thereof will be omitted herein.

When the security level 1 has been set by the hot carrier degradation, the degraded transistor may be recovered by a recovery voltage. Contrarily, when the security level 2 in which the transistor has been permanently destroyed is set, the transistor is not allowed to be recovered any longer even though the recovery voltage is applied.

In a state where the security level 1 or the security level 2 has been set, the transistor temporarily or permanently blocks an access path to a hardware system such as a central processing unit, an auxiliary storage device, etc. However, as described above, when the security level 1 is set, the transistor may be allowed to be recovered by a user or an administrator, or when the security level 2 is set, the transistor is not allowed to be recovered again.

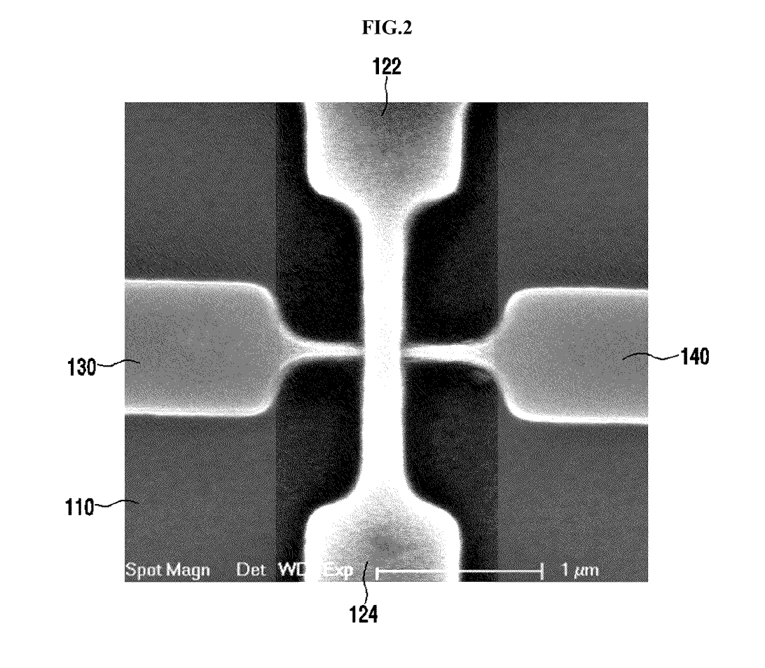

FIG. 2 is a view showing a configuration of the transistor which is used in a security apparatus according to the embodiment of the present invention.

As with a typical field effect transistor, the security apparatus according to the embodiment of the present invention includes a source electrode 130, a drain electrode 140, and gate electrodes 122 and 124. Here, the gate electrodes 122 and 124 include two electrodes, that is, a first gate electrode 122 and a second gate electrode 124.

FIG. 2 is a scanning electron microscope photograph of the transistor used in the security apparatus according to the embodiment of the present invention.

In order to generate the hot carrier degradation which is required by the security level 1, a voltage corresponding to a generation condition of the hot carrier degradation is applied to the source electrode 130, the drain electrode 140, and the gate electrodes 122 and 124. Here, the voltage corresponding to a generation condition of the hot carrier degradation may be appropriately selected depending on a gate and a channel width, etc. Further, a time required for applying the corresponding voltage may be also appropriately selected.

For example, when the length of the gate is 160 nm and the channel width is 38 nm, the hot carrier degradation occurs by floating the second gate electrode 124, by applying a voltage of about 4V to the first gate electrode 122, grounding the source electrode 130, and applying a voltage of about 4.6V for about 1,000 seconds.

If a higher voltage is applied to each of the electrodes, a time required for applying the voltage can be reduced. In the above example, one of the first gate electrode 122 and the second gate electrode 124 is used. When both the first and second gate electrodes 122 and 124 are used, the same amount of voltage may be applied such that a voltage difference between the gate electrodes is 0.

The voltage generating the degradation and the application time of the voltage can be implemented by using a variety of methods. The embodiment of the present invention is not limited to a condition related to the voltage and the application time of the voltage.

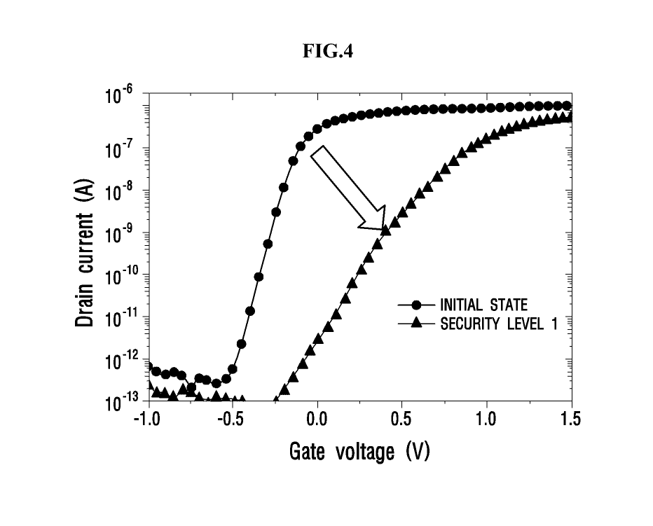

FIG. 4 shows the characteristics of the transistor when the security level 1 is set. FIG. 4 is a graph showing a measurement result of the transistor of which the characteristics have been distorted through the hot carrier degradation in the security apparatus according to the embodiment of the present invention.

The transistor having the characteristics distorted by the hot carrier degradation is the same as temporarily damaged hardware. As a result, an external intrusion path is blocked.

Meanwhile, the characteristics of the transistor, which have been distorted by the hot carrier degradation, can be recovered by applying the recovery voltage. That is, the recovery voltage can recover the hot carrier degradation. The appropriate voltage may be applied to the first gate electrode 122 and the second gate electrode 124 for an appropriate period of time. Hence, the distorted characteristics of the transistor can be recovered to the original characteristics of the transistor.

For example, when the length of the gate is 160 nm and the channel width is 38 nm, a voltage of 3.5 V is applied to the first gate electrode 122 and a voltage of −3.5 V is applied to the second gate electrode 124 for about 1 ms, so that the distorted characteristics of the transistor can be recovered to the original characteristics of the transistor.

Here, depending on the range of the recovery voltage, a degree of recovery of the characteristics of the transistor may be determined differently.

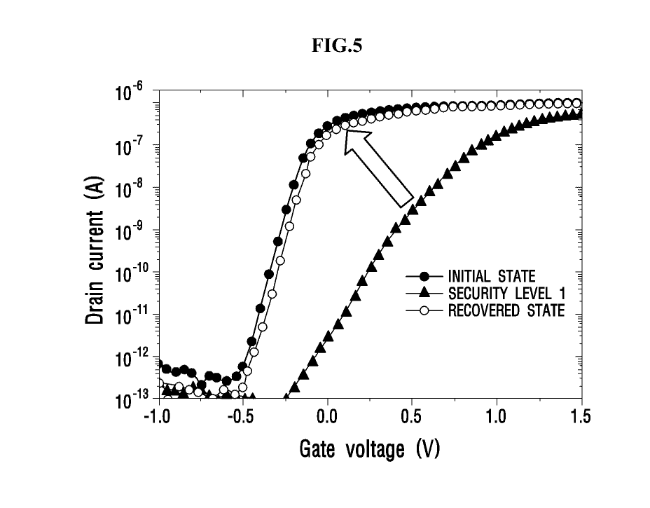

FIG. 5 is a graph showing that the characteristics of the transistor, which have been distorted through the hot carrier degradation by the hot carrier, are recovered by the recovery voltage in the security apparatus according to the embodiment of the present invention. The characteristics of the transistor in an initial state are distorted by setting the security level 1. However, when the recovery voltage is appropriately applied to the two gate electrodes 122 and 124, the characteristic distortion by the hot carrier degradation is recovered and the transistor returns to the initial state.

Meanwhile, the security level 2 may be set by applying a breakdown voltage to the two gate electrodes 122 and 124, regardless of the hot carrier degradation. That is, the security level 2 is set through a thermo-morphic effect (thermal deformation effect) caused by the breakdown voltage application.

For example, when the length of the gate is about 160 nm and the channel width is about 38 nm, a voltage of 4.5 V is applied to the first gate electrode 122 and a voltage of −4.5 V is applied to the second gate electrode 124, so that the security level 2 may permanently destroy the transistor through the thermo-morphic effect.

The permanently destroyed transistor blocks the external intrusion path irrecoverably. In other words, when the security level 2 is set, the transistor (destroyed transistor) blocks fundamentally an access path to a hardware system such as a central processing unit, an auxiliary storage device, etc., thereby achieving stronger security.

Here, depending on the range of the breakdown voltage, a degree of destruction of the characteristics of the transistor may be determined differently.

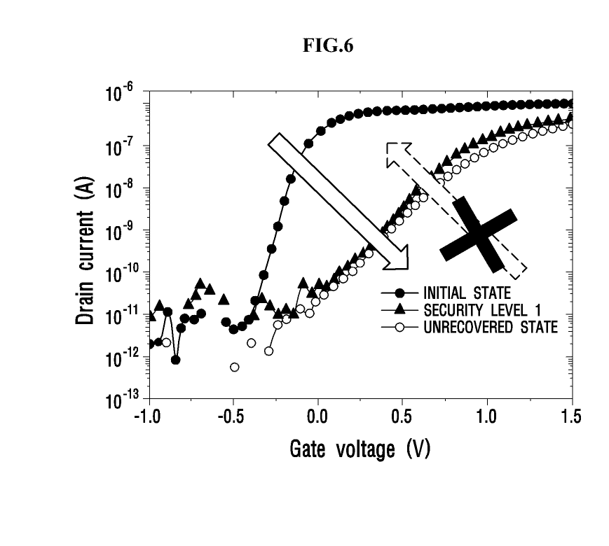

FIG. 6 is a graph showing a state of the transistor destroyed by the breakdown voltage in the security apparatus according to the embodiment of the present invention. The breakdown voltage is applied to both ends of the two gate electrodes 122 and 124 provided on the transistor. Unlike the security level 1, the transistor to which the breakdown voltage has been applied cannot be recovered to the initial state even if the recovery voltage is applied. That is to say, the transistor is permanently destroyed.

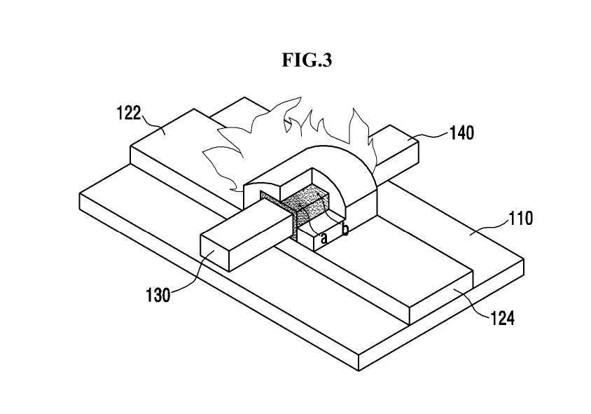

FIG. 3 is a view for describing recovery and destruction of the transistor which is used in the security apparatus according to the embodiment of the present invention.

As shown in FIG. 3, a voltage in a predetermined range is applied to the source electrode 130, the drain electrode 140, and the gate electrode composed of the first gate electrode 122 and the second gate electrode 124, so that it is possible to selectively select the security level 1 and the security level 2. In the drawing, an area “a” represents a state of the gate oxide film of the irrecoverably destroyed transistor, and an area “b” represents a state of the gate oxide film of the transistor which has been recoverably temporarily transformed.

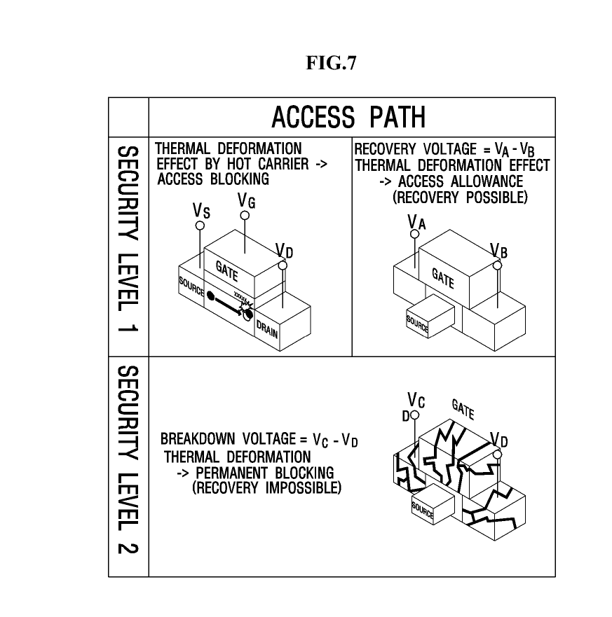

FIG. 7 is a view showing a schematized driving method of the transistor provided in the security apparatus according to the embodiment of the present invention.

As shown in FIG. 7, the transistor distorted by the hot carrier degradation is in the security level 1. In this state, the transistor can be recovered by the thermal deformation effect occurring by the recovery voltage which is applied to both ends of the two gate electrodes.

Contrarily, when the security level 2 is set, the thermal deformation effect occurring by the breakdown voltage applied to both ends of the two gate electrodes is used. Here, the transistor cannot be permanently recovered irrespective of the hot carrier degradation.

In the security apparatus according to the embodiment of the present invention, the security level 1 and the security level 2 can be selectively set by using the above-described principle. A controller (not shown) which selects the security level 1 and the security level 2 monitors the external intrusion continuously.

When the external intrusion is detected, the security apparatus determines a security level for the external intrusion and sets the security level 1 or the security level 2. Here, the determination of the security level can be made by various algorithms and the embodiment of the present invention is not limited to a specific algorithm. That is, when there is a big requirement for system security, the security apparatus may strictly determine the security level. Also, as soon as the external intrusion is detected, the security apparatus sets the security level 1. When a signal of a host is distorted by the external intrusion or a separate operation signal (a signal for enhancing the security) is input from the host, the security apparatus recognizes the signal and sets the security level 2.

The transistor which is used in the security apparatus according to the embodiment of the present invention may be a metal oxide semiconductor field effect transistor. Also, the transistor may be a planar structure transistor, a three-dimensional transistor or a vertically stacked transistor.

Here, the transistor may be a transistor made of III-V material, a transistor having a conductivity increased by adding germanium, a transistor made of 2D material, a transistor including a high-k dielectric material and a metal gate electrode, a junctionless transistor, a transistor made of a polymer organic material, or a transistor made by using a silicon on insulator wafer.

Here, in the transistor made of III-V material, a group III element of Indium (In) and a group V element of phosphorus (P) are mixed to be used as a material of a channel.

In the transistor made of 2D material, at least one of grapheme having at least a monolayer, a carbon nanotube, MoS₂ having at least a monolayer, WSe₂ having at least a monolayer, WS₂ having at least a monolayer may be used as a material of the channel or electrode. Also, the 2D material may be manufactured by an exfoliation process, an atomic layer deposition (ALD) or a chemical vapor deposition (CVD) process, or may be manufactured in a solution state by being mixed with a solvent.

In the transistor including a high-k dielectric material and a metal gate electrode, a dielectric having HfO₂ and a dielectric constant greater than 4 may be used as a gate dielectric.

The transistor made by using an insulation layer buried silicon wafer may include at least one of an insulation layer buried strained silicon, an insulation layer buried germanium, an insulation layer buried strained germanium, and an insulation layer buried silicon germanium.

When the transistor is implemented by the three-dimensional transistor, the transistor may be any one of a FinFET transistor, a Gate-All-Around transistor, a double gate transistor, a Tri-gate transistor, and an omega gate transistor.

Also, when the transistor is implemented by the vertically stacked transistor, the transistor may be a transistor which has been vertically stacked by using a vertical stacking technology such as a through silicon via, etc.

In the meantime, with regard to the use of the transistor, the transistor which is used in the security apparatus according to the embodiment of the present invention may be a transistor used to implement logic as well as security, a transistor which is used in an array or a cell of a flash memory, a transistor which is used in an array or a cell of a D-RAM, a transistor which is used in 1T-DRAM, or a transistor which is used in a unified RAM (U RAM).

The two gate electrodes 122 and 124 provided on the transistor which is used in the security apparatus according to the embodiment of the present invention may be replaced with a high density n-type polysilicon, a high density p-type polysilicon, metallic materials such as TiN, Ti, tungsten, etc., various inorganic and organic matters including high conductive polymer. A silicide film such as NiSi or a technology similar to this may be used.

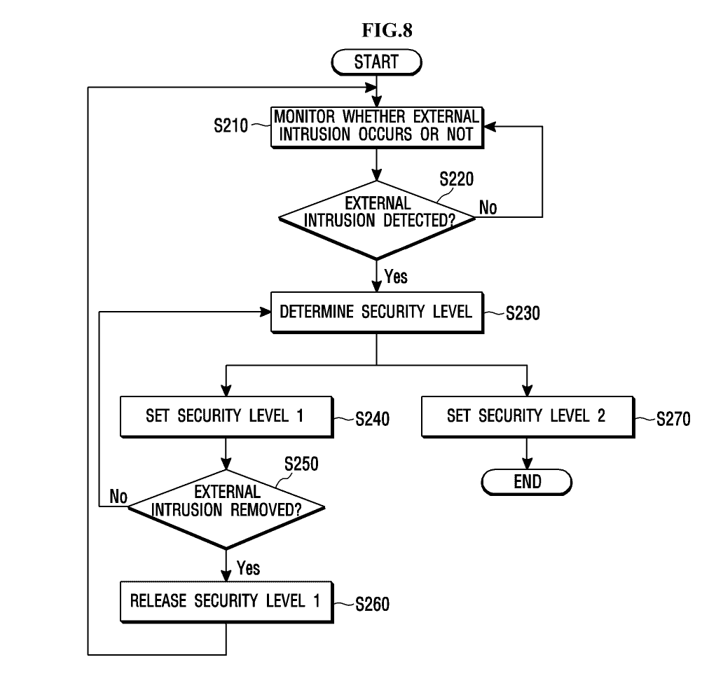

FIG. 8 is a flowchart showing the security method according to the embodiment of the present invention.

In the security method according to the embodiment of the present invention, a controller monitors whether the external intrusion occurs or not (S210). When the external intrusion is not detected (S220-No), the controller continues to monitor the external intrusion (S210).

When the controller detects the external intrusion (S220-Yes), the controller determines the security level (S230). Here, the security level may be set differently depending on a system. For example, in a system which requires high level security, even when a minor external intrusion occurs, the security level 2 may be set by the destruction of the transistor. In another system, only when an input by the user is detected, the controller determines that a high security level is required, and then the security level 2 may be set restrictively.

When the controller determines that a minor security level is required and then the security level 1 is set (S240), the controller distorts the characteristics of the transistor by using the hot carrier degradation, and thus, temporarily blocks the external intrusion path.

When it is determined through the continuous monitoring of the controller that the external intrusion is not removed (S250-No), the controller may continue to determine the security level (S230). If it is determined that the security level becomes higher, the security level 2 may be set.

After the security level 1 is set (S240), when it is determined that the external intrusion is removed (S250-Yes), the controller releases the security level 1. In other words, the controller applies the recovery voltage to the two gate electrodes 122 and 124 provided on the transistor, and thus, the characteristics of the transistor can be recovered to the initial state.

When the characteristics of the transistor are recovered to the initial state, the controller monitors again whether the external intrusion occurs or not (S210), and maintains the security level.

Meanwhile, when the controller determines that a high security level is required (S230), the security level 2 is set. This can be accomplished by applying the breakdown voltage to the two gate electrodes provided on the transistor. Since this corresponds to a permanent destruction, the transistor is not allowed to be recovered any longer. Therefore, the security level for the destructed transistor cannot be set any longer.

However, since a plurality of transistors for security may exist within the system, the controller continues to monitor the external intrusion (S210).

According to the above method of the present invention, the security level 1 and the security level 2 can be selectively set.

The features, structures and effects and the like described in the embodiments are included in one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A hardware-based selective security apparatus comprising:
a transistor comprising a source electrode, a drain electrode, and a gate electrode composed of at least two electrodes; and
a controller which selectively sets any one of security levels having mutually different security ratings by controlling a magnitude of a voltage which is applied to the gate electrode.

2. The hardware-based selective security apparatus of claim 1, wherein the controller applies a voltage in a predetermined range, which distorts characteristics of the transistor, to the source electrode, the drain electrode, and the gate electrode, and thus, sets a security level 1.

3. The hardware-based selective security apparatus of claim 2, wherein the controller applies a recovery voltage for recovering the characteristics of the transistor in the security level 1 to the gate electrode, and then recovers the characteristics of the transistor to an initial state.

4. The hardware-based selective security apparatus of claim 3, wherein, depending on a range of the recovery voltage, a degree of recovery of the characteristics of the transistor is determined differently.

5. The hardware-based selective security apparatus of claim 2, wherein the characteristics of the transistor are distorted by any one of a hot carrier, Fowler-Nordheim (FN) tunneling, negative bias temperature instability (NBTI), positive bias temperature instability (PBTI), transistor degradation by a radiation.

6. The hardware-based selective security apparatus of claim 1, wherein the controller applies a breakdown voltage, which destroys the transistor irrecoverably, to the gate electrode, and thus, sets a security level 2.

7. The hardware-based selective security apparatus of claim 6, wherein the irrecoverable destruction of the transistor comprises physical destruction, chemical destruction, physical/chemical/electrical destructions of a gate insulator, and channel area destruction.

8. The hardware-based selective security apparatus of claim 6, wherein, depending on a range of the breakdown voltage, a degree of destruction of the characteristics of the transistor is determined differently.

9. The hardware-based selective security apparatus of claim 1, wherein the security level comprises a recoverable security level 1 and an irrecoverable security level 2.

10. A hardware-based selective security method comprises:
monitoring whether an external intrusion into a system occurs or not;
determining a security rating for the detected external intrusion; and
setting any one of security levels having mutually different security ratings in accordance with the determined security rating.

11. The hardware-based selective security method of claim 10, wherein the setting the security level means that a recoverable security level 1 or an irrecoverable security level 2 is set.

12. The hardware-based selective security method of claim 11, wherein the security level 1 and the security level 2 are applied by distorting or destroying characteristics of at least one transistor provided within the system.

13. The hardware-based selective security method of claim 12, wherein the at least one transistor is distorted by applying a voltage in a predetermined range to a source electrode, a drain electrode, and a gate electrode provided in the transistor, and wherein the at least one transistor is recovered by applying a recovery voltage in a predetermined range to the gate electrode provided in the transistor.

14. The hardware-based selective security method of claim 12, wherein the at least one transistor is destroyed by applying a breakdown voltage to the gate electrode provided in the transistor.

15. The hardware-based selective security method of claim 11, wherein, when it is determined that the external intrusion is removed after the security level 1 is set, at least one of the distorted characteristics of the transistor are recovered to an initial state, and then the security level 1 is released.
